(19) United States
(12) Patent Application Publication
(10) Pub. No.: US 2015/0075637 A1
(43) Pub. Date: Mar. 19, 2015

(54) TRAVELING VALVE CAGE

(71) Applicant: David GRONNING, Beaumont (CA)

(72) Inventor: David GRONNING, Beaumont (CA)

(73) Assignee: GLOBAL OIL AND GAS SUPPLIES INC., Beaumont (CA)

(21) Appl. No.: 14/473,525

(22) Filed: Aug. 29, 2014

Related U.S. Application Data
(60) Provisional application No. 61/878,953, filed on Sep. 17, 2013.

(51) Int. Cl. F16K 15/04; F04B 53/10; E21B 34/16; F16K 47/08

(52) U.S. Cl. CPC F16K 15/04; F16K 47/08; F04B 53/1002; E21B 34/16
USPC 137/15.22; 137/515

(57) ABSTRACT

A traveling valve for use with a downhole pump includes a cage shell, which at its lower end, has an integral internal shoulder that defines an axial opening. A retaining ring within the cage shell abuts the internal shoulder. An upper end of a bushing is attachable to a plunger while the lower end of the bushing is attached to the cage shell. The bushing and cage shell define a bore in fluid communication with the axial opening. An insert within the bore allows fluid to flow in the bore from below the insert to above the insert. A ball reciprocates in the bore so as to seat on the retaining ring when the fluid pressure within the bore above the ball exceeds the fluid pressure within below the ball, and to be restrained by the insert when the fluid pressure differential within the bore is reversed.

### CROSS-REFERENCE TO RELATED APPLICATIONS

This application claims the priority benefit of U.S. Provisional Patent Application No. 61/878,953, entitled “Valve Cage” and filed on Sep. 17, 2013, the entire contents of which are incorporated herein by reference.

### FIELD OF THE INVENTION

The present invention relates to a traveling valve for use with a downhole pump having a plunger.

### BACKGROUND

Walking beam pumps or pump jacks, also known as rocking horse or sucker rod pumps, are well known in the oil and gas industry. The pump jack reciprocates a sucker rod string in the tubing of the wellbore, which extends to the production zone.

At the bottom of the tubing is the downhole pump. This pump typically has two check valves: a stationary valve at the bottom of the pump, called the standing valve; and a valve on the piston connected to the bottom of the sucker rod string that reciprocates up and down, known as the traveling valve. Reservoir fluid enters into the wellbore from the formation into the bottom of the borehole through perforations that have been made through the casing and cement.

When the traveling valve is moving upwards, it is closed and the standing valve is open, due to the drop in pressure in the pump barrel. Consequently, the traveling valve lifts the contents of the pump barrel upwards into the production tubing, while the pump barrel fills with fluid from the formation. When the traveling valve moves downwards, it opens and the standing valve closes due to an increase in pressure in the pump barrel. The traveling valve drops through the fluid and the pump fills with fluid from the formation. The piston then reaches the end of its stroke and begins its path upwards again, repeating the process.

### SUMMARY OF THE INVENTION

In general terms, the invention relates to a traveling valve for use with a downhole pump having a plunger.

In one aspect, the invention provides a traveling valve that comprises:

(a) a cage shell having a lower end and an upper end, wherein the lower end comprises an internal shoulder defining an axial opening; and

(b) a retaining ring disposed within the cage shell and abutting the internal shoulder;

(b) a bushing having a lower end adapted to engage the upper end of the cage shell, and an upper end adapted to engage the plunger, wherein the bushing and cage shell together define a bore in fluid communication with the axial opening;

(c) a ball disposed within the bore, wherein the ball reciprocates between a position seated against the retaining ring and a position spaced away from the retaining ring; and

(d) an insert secured within the bore and around the ball, comprising a ball retaining portion, and defines at least one opening allowing fluid communication from within the insert to the bore above the insert.

In one embodiment of the valve, the retaining ring is separable from the internal shoulder. Alternatively, the retaining ring may be integral with the internal shoulder. In one embodiment of the valve, the lower end of the cage shell is not threaded. In one embodiment of the valve, the lower end of the bushing and the upper end of the cage shell are adapted to engage each other with a threaded connection. Either or both the bushing and the cage shell may define wrench flats.

In one embodiment of the valve, the insert may be cylindrical and fit closely within the cage shell. The cylindrical insert may have a lower end that abuts the retaining ring, and an upper end that abuts the bushing. A sealing element may be provided between and abutting the bushing and the cylindrical insert. A side wall of the cylindrical insert may define the at least one insert opening and may further define a channel that extends the at least one insert to an upper surface of the insert. The ball retaining portion of the cylindrical insert may comprise a conically shaped surface of the insert, and may define a central opening.

In another aspect, the invention provides a method of assembling a traveling valve, the method comprising the steps of:

(a) placing a ball into a bore formed by a cage shell having an integral lower internal shoulder and an upper threaded end;

(b) placing an insert having a ball retaining portion within the cage shell and around the ball; and

(c) threading a bushing to the upper threaded end of the cage shell to retain the insert.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 shows a partial exploded cutaway view of one embodiment of a traveling valve of the present invention.

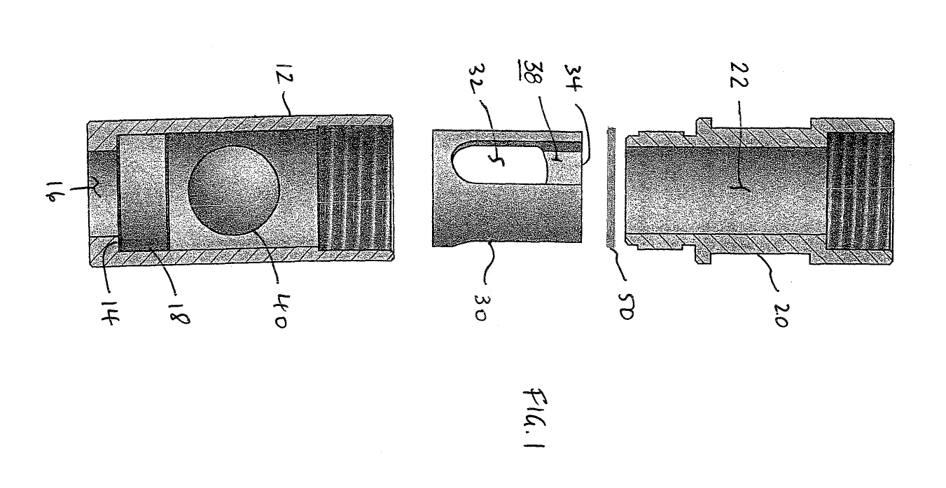

FIG. 2 shows a cross-sectional view of the embodiment of the traveling valve of FIG. 1, when assembled.

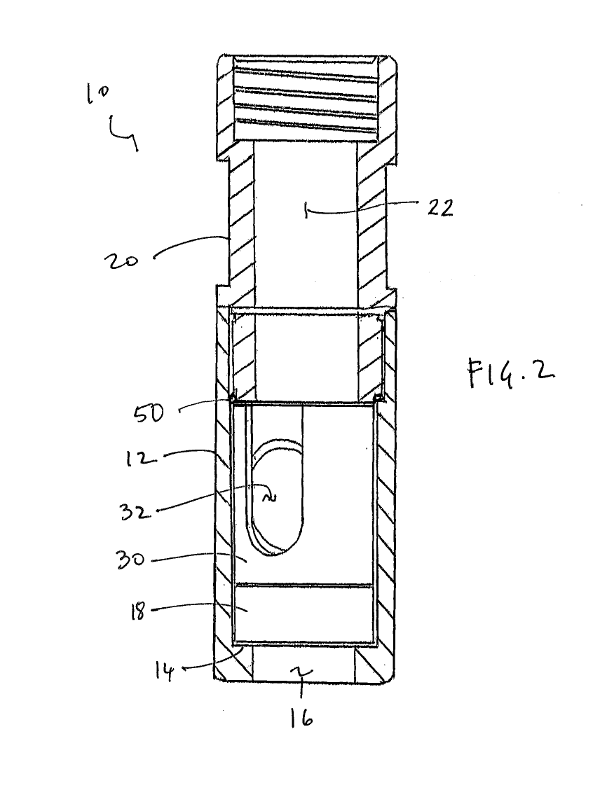

FIG. 3A shows a side view of one embodiment of the insert of the embodiment of the traveling valve of FIG. 1. FIG. 3B shows a cross-sectional view along line 3B shown in FIG. 3C, which is a top plan view of the insert of FIG. 3A.

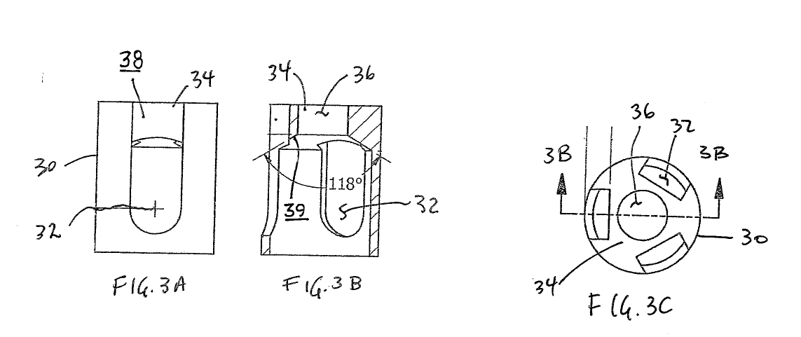

### DETAILED DESCRIPTION OF PREFERRED EMBODIMENTS

Embodiments of the invention are described below. Reference to “upper” and “lower” are used to describe the orientation of components as they would normally be used in a vertical or near-vertical wellbore. It is not intended to restrict the use of the traveling valve in any orientation. The traveling valve may be used in vertical, slanted, or horizontal wellbores, as is well known in the art.

In one embodiment as shown in the Figures, the invention may comprise a traveling valve (10) for use with a downhole pump having a plunger, the valve (10) comprising:

(a) a cylindrical cage shell (12) having a lower end and an upper end, wherein the lower end comprises an integral internal shoulder (14) defining an axial opening (16);

(b) a retaining ring (18) disposed within the cage shell (12) and abutting the internal shoulder (14);

(c) a cylindrical bushing (20) having a lower end adapted to engage the upper end of the cage shell (12), and an upper end adapted to engage the plunger (not shown), wherein the bushing and the cage shell together define a bore (22) in fluid communication with the axial opening (16);

(c) a cylindrical insert (30) disposed within the part of the bore (22) defined by the cage shell (12), wherein the insert (30) comprises a ball retaining portion (34), and defines at least one opening (32) allowing fluid flow in the bore (22) from within the insert (30) to above the insert (30); and

(d) a ball (40) that reciprocates within the insert (30) between seating against the retaining ring (18) and a position spaced apart from the retaining ring (18), where the travel of the the ball is restrained by the ball retaining portion (34) of the insert (30).

In the embodiment shown in the Figures, the ball retaining portion (34) extends transversely across the bore of the insert (30). The ball retaining portion (34) may have a central opening (36). The insert (30) may have openings (32) through the side wall of the insert (30) and channels (38) which extend the openings (32) towards an upper end of the insert (32). The ball retaining portion (34) may have an internal ball contact surface (39) that is conically shaped, sloping vertically towards the central opening (36).

The components of the traveling valve may be constructed of a high strength, wear and corrosion resistant material, such as steel, stainless steel, cobalt alloys or other suitable alloys. The insert (30) typically will experience significant wear, and may therefore be constructed of more wear-resistant material.

The bushing (20) and/or the lower cage shell (12) may have wrench flats for convenient assembly. The components may connect together with conventional threaded attachments.

In a conventional traveling valve, the bottom end comprises a sealed seat plug which is attached to the cage shell, such as by a threaded attachment. In the present invention, the seat plug is omitted, and is replaced by the integrally formed lower internal shoulder (14) and the retaining ring (18). As a result, the travelling valve (10) can be positioned closer to the stationary valve at the bottom of its stroke, increasing the potential compression that may be achieved.

In the embodiment shown in the Figures, the traveling valve (10) is assembled by placing the retaining ring (18) and the ball (40) within the lower cage shell (12) and placing the insert (30) within the lower cage shell (12) around the ball (40). These components can be so placed in the cage shell (12) by dropping the retaining ring (18), followed by the ball (40), followed by the insert (30) into the cage shell (12). The bushing (20) may then be threaded onto the cage shell (12). The retaining ring (18) abuts against the bottom end of the insert (30), while the bushing (20) abuts against the top end of the insert (30), thus retaining the insert (30) in place. The lower end of the cage shell (12) does not have any threads. Accordingly, the traveling valve (10) cannot be assembled or installed upside-down on the sucker rod, which is a relatively common mistake when assembling travelling valves.

In other embodiments of the valve (10) (not shown), the retaining ring (18) may be formed integrally with the internal shoulder (14) of the valve cage (12) rather than as a separate part as in the embodiment shown in the Figures. The insert (30) may have a non-cylindrical in shape. The insert (30) may be disposed within the part of the bore (22) defined by the bushing (20) alone, or by both the valve cage (12) and bushing (20). The insert (30) may be retained in the bore (22) by indirectly abutting the valve cage (12) and the bushing (20), or by abutting other components such as internal lugs or catches.

In use, when the traveling valve (10) ascends, the fluid pressure above the insert (30) is greater than fluid pressure below the insert (30). In response, the ball (40) is seated on the retaining ring (18) and does not permit fluid to flow past the ball (40) and the retaining ring (18), thus lifting a column of fluid above the valve (10) towards the surface. When the traveling valve (10) descends the tubing in a wellbore, the fluid pressure differential is reversed. In response, the ball (40) unseats from the retaining ring (18) and fluid may flow upwards through the retaining ring (18), around the ball (40) and pass through openings (32) defined by the insert (30) into and through the bushing (20). The lateral openings (32) in the insert (30) side wall allow fluid to pass between the insert (30) and the cage shell (12). These openings (32) extend into channels (38) in the side wall of the insert (30) that extend to the upper end of the insert (30), and provide fluid communication into the part of the bore (22) defined by the bushing (20).

The ball (40) may contact the ball retaining portion (34) and the retaining ring (18) with some force. A conventional seal, such as an O-ring (50), may provide a seal and cushion between the insert (30) and the bushing (20).

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A traveling valve for use with a downhole pump having a plunger, the valve comprising:
(a) a cage shell having a lower end and an upper end, wherein the lower end comprises an internal shoulder defining an axial opening; and
(b) a retaining ring disposed within the cage shell and abutting the internal shoulder;
(b) a bushing having a lower end adapted to engage the upper end of the cage shell, and an upper end adapted to engage the plunger, wherein the bushing and cage shell together define a bore in fluid communication with the axial opening;
(c) a ball disposed within the bore, wherein the ball reciprocates between a position seated against the retaining ring and a position spaced away from the retaining ring; and
(d) an insert secured within the bore and around the ball, comprising a ball retaining portion, and defines at least one opening allowing fluid communication from within the insert to the bore above the insert.

2. The valve of claim 1 wherein the retaining ring is separable from the internal shoulder.

3. The valve of claim 1 wherein the retaining ring is integral with the internal shoulder.

4. The valve of claim 1 wherein the insert is cylindrical and the ball reciprocates within the insert.

5. The valve of claim 4 wherein the insert has a lower end that abuts the retaining ring, and an upper end that abuts the bushing.

6. The valve of claim 4 further comprising a sealing element between and abutting the valve cage and the bushing.

7. The valve of claim 4 wherein a side wall of the insert defines the at least one insert opening.

8. The valve of claim 7 wherein the side wall of the insert further defines an external channel that extends the at least one insert opening to an upper surface of the insert.

9. The valve of claim 4 wherein the ball retaining portion of the insert comprises an internal vertically sloped surface of the insert.

10. The valve of claim 9 wherein the internal vertically sloped surface defines a central opening of the insert.

11. The valve of claim 1 wherein the lower end of the bushing and the upper end of the cage shell are adapted to engage each other with a threaded connection.

12. The valve of claim 11 wherein one or both of the cage shell and the bushing define wrench flats.

13. The valve of claim 1 wherein the lower end of the cage shell is not threaded and/or does not comprise a seat plug.

14. A method of assembling a traveling valve for use with a downhole pump having a plunger, the method comprising the steps of:
(a) placing a ball into a bore formed by a cage shell having an integral lower internal shoulder and an upper threaded end;
(b) placing an insert having a ball retaining portion within the cage shell and around the ball; and
(c) threading a bushing to the upper threaded end of the cage shell to retain the insert.

15. The method of claim 14 further comprising, prior to the step of placing the ball and the insert into the bore, the step of placing a retaining ring against the lower integral internal shoulder of the cage shell.

16. The method of claim 14 wherein the insert is placed around the ball, so that the ball reciprocates within the insert.

17. The method of claim 16 wherein, when the bushing is attached to the cage shell, a lower end of the insert abuts the retaining ring, while an upper end of the insert abuts the bushing.

18. The method of claim 14 wherein the bushing is attached to the cage shell by a threaded connection.
